(19) United States
(12) Patent Application Publication
(10) Pub. No.: US 2015/0307131 A1
(43) Pub. Date: Oct. 29, 2015

(54) Autonomous Driving in a Hazard Situation

(71) Applicant: Bayerische Motoren Werke Aktiengesellschaft, Muenchen (DE)

(72) Inventor: Joachim FROESCHL, Herrsching (DE)

(21) Appl. No.: 14/693,321

(22) Filed: Apr. 22, 2015

(30) Foreign Application Priority Data
Apr. 23, 2014 (DE) 10 2014 207 666.8

(51) Int. Cl. B62D 15/02; G01S 13/93; G01S 15/93

(52) U.S. Cl. CPC B62D 15/025; G01S 15/931; G01S 13/931

(57) ABSTRACT

What is described is a motor vehicle having a sensor unit and a control device that is set up to steer the motor vehicle along an intended trajectory on the basis of data captured by the sensor unit. The control device has an evaluation device that is set up to take captured and/or received data as a basis for identifying a vehicle with a special task and/or a vehicle traveling in the wrong direction of travel and to take account of captured and/or received data that can be associated with the identified vehicle for ascertaining and/or steering along the intended trajectory. In addition, a method for autonomously controlling a motor vehicle is described. The method involves captured and/or received data being taken as a basis for identifying a vehicle with a special task and/or a vehicle traveling in the wrong direction of travel, and captured and/or received data that can be associated with the identified vehicle are taken into account for ascertaining and steering along an intended trajectory.

### CROSS REFERENCE TO RELATED APPLICATION

This application claims priority under 35 U.S.C. §119 from German Patent Application No. 10 2014 207 666.8, filed Apr. 23, 2014, the entire disclosure of which is herein expressly incorporated by reference.

### BACKGROUND AND SUMMARY OF THE INVENTION

The invention relates to a motor vehicle having a sensor unit and a control device that is set up to steer the motor vehicle along an intended trajectory on the basis of data captured by the sensor unit. In addition, the invention relates to a method for autonomously controlling a motor vehicle.

Conventionally, control devices for autonomous driving, for ascertaining the optimum route and speed, as lane departure warning systems, for overtaking maneuvers, for traveling along expressways and for parking are used in motor vehicles. However, there is a need for the driver to be assisted in more complex situations, requiring additional information about the other road users, too. Particularly in hazard situations that are not evident from the direct surroundings of the vehicle, it has hitherto been impossible for autonomously driven vehicles to react thereto in an appropriate manner.

Serious accidents often require rapid rescue assignments. In this case, it is particularly important for the rescue vehicles involved not to be impeded by vehicles traveling along the path to the rescue assignment. Frequently, however, vehicles that are on the path of the rescue vehicle do not recognize the rescue vehicles approaching behind them, for example, until very late. Not only does this impede the assignment and hence expose accident victims who are in a critical condition, for example, to additional risks, there is also the danger of the quickly traveling rescue vehicle becoming involved in a serious collision.

DE 101 08 162 A1 describes a warning device in motor vehicles for the deployment of fire, police and other rescue vehicles using the radio frequencies as visual and audible warning indicators. However, there is the danger that the driver in question does not react to the warning signal in an appropriate manner, for example because it is drowned out by noisy traffic or loud music or because the driver is alarmed by the signal or does not know the direction from which the rescue vehicle is approaching and perhaps even causes an additional danger as a result of a reaction prompted by the alarm.

It is therefore an object of the invention to develop a motor vehicle that can react to such hazard situations more appropriately.

The invention achieves this object by means of the subject matter of the independent claims. The dependent patent claims are advantageous developments of the invention, there being particularly the possibility of developing the claims in one category in accordance with dependent claims in another claim category.

The control device of the motor vehicle according to the invention has an evaluation device that is set up to take captured and/or received data as a basis for identifying a vehicle with a special task and/or a vehicle traveling in the wrong direction of travel. In addition, the control device is set up to take account of captured and/or received data that can be associated with the identified vehicle for ascertaining and/or steering along the intended trajectory. The automatic and specific identification of hazard situations and the automatic changeover to an appropriately adjusted driving mode reduces the danger of an unduly late or incorrect reaction to a suddenly changing situation and additionally relieves the load on the driver.

The method according to the invention for autonomously controlling a motor vehicle involves captured and/or received data being taken as a basis for identifying a vehicle with a special task and/or a vehicle traveling in the wrong direction of travel, and captured and/or received data that can be associated with the identified vehicle being taken into account for ascertaining and steering along an intended trajectory. Taking account of the data that can be associated with the identified vehicle can particularly involve changing to a special driving mode, with particular behaviors linked to the special task of the identified vehicle, traffic situations and changes of traffic rules being taken into account.

According to a particularly advantageous development, the sensor unit of the motor vehicle according to the invention has an acoustic sensor unit and/or an optical sensor unit and/or a transmission/reception unit and/or a radar unit and/or an infrared unit. Firstly, said sensor units can be used to pick up physical measured values and, in a further step, to process them further to produce more complex information. Secondly, the reception units can also receive signals or messages directly and use them for identification or combine them with physical measured values or evaluate them synergistically.

By way of example, the detected vehicle with a special task may be a police vehicle or an ambulance or a fire-fighting vehicle or a vehicle of the federal border guard or a military vehicle and/or a vehicle for a group of people charged with a public office. Thus, a ready field of application is obtained for the subject matter of the invention. For each of the cited vehicles with special tasks, there may be a separate driving mode with special routines matching the respective properties and behaviors of the individual vehicle types or the tasks thereof, for example in a memory device of the motor vehicle according to the invention.

The data captured or received by the motor vehicle according to the invention may be based on a blue light, an audible warning signal, a piece of information transmitted by radio and/or mobile radio, a piece of information from Car2x communication, a piece of information transmitted by the identified vehicle or a piece of information transmitted by a control center, for example. According to a special variant, the evaluation device may be set up to process the received or captured data by means of evaluation of audible data, visual data, radio data, by means of Doppler evaluation, by means of traffic information evaluation or by means of evaluation of a piece of information from Car2x communication. Car2x communication denotes vehicle-to-vehicle and vehicle-to-infrastructure communication, which is based both on matched wireless LAN technology and on mobile radio.

It is thus possible to evaluate information of various complexity and from different entities. A synopsis of the various information ultimately results in a differentiated picture of the current hazard situation and allows the control device to react thereto in an appropriate manner.

Preferably, the control device may be set up to locate the identified vehicle on the basis of the captured and/or received data that can be associated with the identified vehicle. The captured or received data that are used for locating the identified vehicle may be simple sensor data that can then be used to reconstruct the position of the identified vehicle. Alternatively, the data can be sent as messages by different entities, for example the identified vehicle itself or a traffic control center, specifically in a format that allows automatic identification of the content of the message. In addition, these data may also be position data produced by geopositioning systems or other locating systems or self-locating systems, for example. In particular, they may be data from the GPS system or from a comparable system such as GLONASS or GALILEO or Beidou (Compass).

The control device of the motor vehicle according to the invention may be set up to ascertain an intended trajectory, and to control the motor vehicle, such that the probable path of the identified vehicle is kept clear and a collision with the identified vehicle is avoided. The control device according to the invention thus automatically performs functions that the driver of a motor vehicle conventionally needs to perform itself, thereby firstly increases safety for the passengers and secondly relieves the driver of the task of continually observing and correctly assessing a traffic situation. Particularly road users who are elderly, for whom participation in ever more dense road traffic is relatively difficult on account of weaker sensory performance, longer reaction times and a generally reduced capability of correctly interpreting complex, rapidly changing situations, are able to participate in road traffic to an increased extent again by virtue of the automatic control of the vehicle with the described features.

According to a particularly preferred embodiment of the invention, the control device may be set up to match the speed of the motor vehicle to a hazard situation linked to the identified vehicle. The speed matching first of all prevents the risk of accident and secondly also prevents erratic driving, which can more readily avoid stop-go traffic and queues.

In addition, the control device may be set up to initiate transfer of command to the driver.

In addition, the control device may be set up to take the captured information as a basis for locating a hazard spot and bypassing the hazard spot.

According to a particularly feasible embodiment of the invention, the control device may be set up to modify the driving behavior of the motor vehicle at intersections and junctions on the basis of the captured and/or received data. By way of example, particular vehicles, such as rescue vehicles or police vehicles, can be granted priority, in principle, but only if it has been ascertained that said special vehicles are also on an assignment.

The control device may additionally be set up to switch on warning signals from the motor vehicle. By switching on warning signals, such as the warning light, it is possible to warn the other road users, who may not have the control device according to the invention.

The control device may preferably be set up to take the captured and received data as a basis for performing system conditioning for the motor vehicle in respect of dynamic evasive maneuvers or waiting times. In other words, particular functions of the vehicle that are absolutely necessary can be ensured by matched control operations over a long period, for example. In particular, this can safeguard the power supply, for example by shutting down loads that are not absolutely necessary, or other fuel saving measures, onboard power supply system stability and air conditioning in extreme weather conditions.

The control device may be set up to take captured and received data as a basis for controlling the lighting system to avoid disturbing the identified vehicle and/or the audio system to increase the awareness of the driver. By way of example, the headlights can be dipped or a fog lamp can be temporarily deactivated so as not to dazzle rescue vehicles.

An exemplary embodiment of the invention is illustrated in the drawing, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of a motor vehicle based on an exemplary embodiment of the invention,

FIG. 2 shows a flowchart that illustrates a method according to an exemplary embodiment of the invention.

### DETAILED DESCRIPTION OF THE DRAWINGS

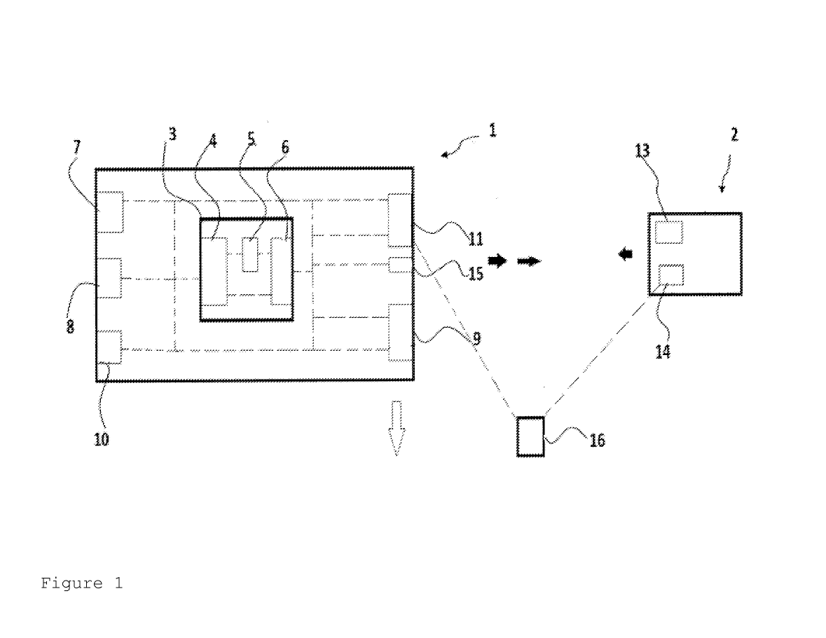

FIG. 1 schematically shows a motor vehicle 1. The motor vehicle 1 has a plurality of different sensor units 7, 8, 9, 10. The dashed lines between the individual units are meant to represent data communication lines or data communication channels between the individual units. An acoustic sensor unit 7 receives sounds and audible signals. An audible signal may be a special signal or a signal from a siren, for example. An optical sensor unit 8 can comprise a camera and/or an optical scanning system based on Lidar, for example. A radar unit 9 is used to locate objects and to scan the environment with microwaves. An infrared unit 10 detects infrared lightwaves reflected or transmitted by objects. In addition, the vehicle 1 also contains a transmission/reception unit 11 for communication via radio signals, for example with a traffic control center, a rescue control center 16 or another vehicle 2 equipped for special tasks. The other vehicle 2 may be a rescue vehicle, for example. It has an audible signal installation, i.e. a siren 13. In addition, the vehicle 2 comprises a transmission/reception unit 14 that it can also use to communicate directly with the rescue control center 16 and possibly also with other motor vehicles, such as the motor vehicle 1. The motor vehicle 1 additionally has a control device 3 that comprises an evaluation unit 4. The evaluation unit 4 receives the sensor data captured by the sensor units and also received data such as signals, particularly radio signals. These data are also processed using additional information stored in data memories or databases, and the current traffic situation prevailing around the motor vehicle is reconstructed or mapped. By way of example, the vehicle-inherent camera signals can be evaluated by means of image processing. This can involve a blue light being detected, for example. The audible signals can be analyzed by means of Doppler evaluation, for example, so that it is possible to ascertain whether the identified emergency vehicle is approaching or moving away. In addition, the evaluation unit can also evaluate information from Car2x communication. By way of example, a rescue vehicle can forward its probable journey route to the motor vehicle 1 by radio or another data transmission technique. On the basis of this evaluation, the selection unit 5 selects a driving mode in which the vehicle needs to be controlled. By way of example, this driving mode may be a “rescue assignment” driving mode if the evaluation unit 4 has ascertained a rescue vehicle. The selected driving mode is transmitted to the actuation unit 6. The actuation unit 6 actuates various important functional elements of the motor vehicle 1, such as the steering, the brakes, the fuel metering (“gas”), the actuation of an electric drive (in the case of electric and hybrid vehicles), a gear, the lighting installation 15 and many other units that are important to the operation of the motor vehicle in the selected special driving mode. The special “rescue assignment” driving mode can comprise the following special driving maneuvers and routines, for example: keeping an emergency corridor clear, increasing the distance from the vehicle traveling in front. The effect intended to be achieved by the latter is to maintain the flow of traffic, and additionally the effect intended to be achieved thereby is that other road users are capable of forming an emergency corridor. In addition, the special driving mode comprises evasive action, including onto grass verges or the like, possibly by means of transfer of command and recommendation to the driver, and bypassing an accident spot. The special driving mode also has an influence on driving behavior at intersections, i.e. right of way is yielded, for example, even though the ego vehicle actually has right of way. In addition, the special driving mode can also comprise avoiding overtaking other vehicles so as not to endanger or impede other vehicles, particularly the identified vehicle. Finally, the special driving mode can involve switching on the hazard warning lights of the ego vehicle in order to warn other road users. These maneuvers are controlled automatically by the control device 3 without the driver needing to intervene in the control of the motor vehicle 1. The black arrows indicate a direction of travel for the two vehicles 1, 2. The two vehicles are on a collision course. After the rescue vehicle 2 has been identified by the evaluation device 4 of the motor vehicle 1, the motor vehicle 1 changes to the “rescue assignment” driving mode and initiates an evasive maneuver. This is indicated by the white arrow.

A second “accident prevention” driving mode can comprise matching the control of the motor vehicle 1 to a hazard situation, such as the occurrence of a driver driving along a road the wrong way. In this case, a recommended lane and speed are observed in the event of an oncoming driver driving along a road the wrong way, and if need be an evasive maneuver is initiated in order to avoid a collision or to lessen damage.

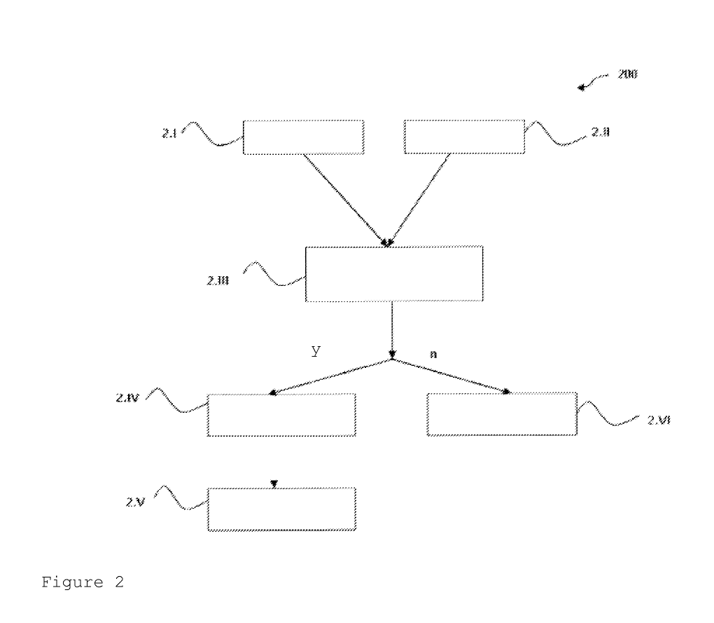

FIG. 2 shows a flowchart that illustrates a method 200 for autonomously controlling a motor vehicle 1 according to an exemplary embodiment of the invention. It is assumed that the motor vehicle is initially in a standard mode, i.e. in a mode that is also used for conventional autonomously driven vehicles. In step 2.I, sensor data are captured by different sensors in the motor vehicle 1. In step 2.II, additional information is received, for example by radio, concerning the current traffic situation. All of these data are processed in step 2.III. The method ascertains whether a vehicle with a special task, for example a rescue vehicle on an assignment, is approaching the motor vehicle 1. If a special vehicle of this kind is detected in step 2.III, which is denoted by “y” in FIG. 2, then an appropriate driving mode is selected in step 2.IV. If a rescue vehicle is detected, the “rescue assignment” driving mode is selected, for example. In this case, step 2.V involves the motor vehicle being controlled in accordance with the routines associated with the special driving mode. By way of example, the motor vehicle 1 is automatically driven onto the shoulder in order to form an emergency corridor. Further routines of the special “rescue assignment” driving mode have already been described in detail. If a vehicle occupied with a special task is not detected in step 2.III, which is denoted by “n” in FIG. 2, then the standard mode is retained or, if the motor vehicle 1 is still in a special driving mode, the standard mode is selected again in step 2.VI. The method described can be carried out in a loop, i.e. the method steps are continually repeated. By way of example, after step 2.V, when the motor vehicle is in a special driving mode, the method returns to steps 2.I and 2.II again. If step 2.III subsequently ascertains that a vehicle with a special task is no longer in the vicinity, the method continues with step 2.VI. In this case, the motor vehicle then returns from the special mode, for example “rescue assignment” mode, to a standard mode again.

Finally, it is once again pointed out that the motor vehicle 1 shown in the figures and the method described in detail are just an exemplary embodiment that can be modified in many respects. In addition, for the sake of completeness, it is also pointed out that the use of the indefinite articles “a” and “an” does not preclude the relevant features from also being present a plurality of times. Similarly, the term “unit” does not preclude this from also consisting of a plurality of subunits.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle having a sensor unit and a control device that is configured to steer the motor vehicle along an intended trajectory on the basis of data captured by the sensor unit, wherein the control device comprises an evaluation device that is configured to take captured and/or received data as a basis for identifying a vehicle with a special task and/or a vehicle traveling in the wrong direction of travel and to take account of captured and/or received data that can be associated with the identified vehicle for ascertaining and/or steering along the intended trajectory.

2. The motor vehicle as claimed in claim 1, wherein the sensor unit comprises at least one of an acoustic sensor unit, an optical sensor unit, a transmission/reception unit, a radar unit and an infrared unit.

3. The motor vehicle as claimed in claim 1, wherein the vehicle with a special task is one of a police vehicle, an ambulance, a fire-fighting vehicle, a vehicle of the federal border guard, a military vehicle, and a vehicle for a group of people charged with a public office.

4. The motor vehicle as claimed in claim 1, wherein the captured and/or received data are based at least on one of the following pieces of information:
a blue light,
an audible warning signal,
a piece of information transmitted by radio and/or mobile radio,
a piece of information from Car2x communication,
a piece of information transmitted by the identified vehicle, and
a piece of information transmitted by a control center.

5. The motor vehicle as claimed in claim 1, wherein the control device is configured to locate the identified vehicle on the basis of the captured and/or received data that can be associated with the identified vehicle.

6. The motor vehicle as claimed in claim 1, wherein the control device is configured to ascertain an intended trajectory, and to control the motor vehicle, such that the probable path of the identified vehicle is kept clear and a collision with the identified vehicle is avoided.

7. The motor vehicle as claimed in claim 1, wherein the control device is configured to match the speed of the motor vehicle to a hazard situation linked to the identified vehicle.

8. The motor vehicle as claimed in claim 1, wherein the control device is configured to take the captured and/or received data as a basis for locating a hazard spot and bypassing the hazard spot.

9. The motor vehicle as claimed in claim 1, wherein the control device is configured to modify the driving behavior of the motor vehicle at intersections and junctions on the basis of the captured and/or received data.

10. A method for autonomously controlling a motor vehicle, wherein captured and/or received data are taken as a basis for identifying a vehicle with a special task and/or a vehicle traveling in the wrong direction of travel, and captured and/or received data that can be associated with the identified vehicle are taken into account for ascertaining and steering along an intended trajectory.
